(19) United States
(12) Patent Application Publication
(10) Pub. No.: US 2025/0216326 A1
(43) Pub. Date: Jul. 3, 2025

(54) LIQUID HYDROGEN RATIO ANALYSIS SYSTEM AND LIQUID HYDROGEN RATIO ANALYSIS METHOD

(71) Applicants: Hyundai Motor Company, Seoul (KR); Kia Corporation, Seoul (KR); CHUNG ANG University Industry Academic Cooperation Foundation, Seoul (KR)

(72) Inventors: Seung Joon LEE, Hwaseong-si (KR); Se Kwon JUNG, Hwaseong-si (KR); Hyung Bin SON, Seoul (KR); Seok In KIM, Seoul (KR)

(73) Assignees: Hyundai Motor Company, Seoul (KR); Kia Corporation, Seoul (KR); CHUNG ANG University Industry Academic Coorperation Foundation, Seoul (KR)

(21) Appl. No.: 18/937,610

(22) Filed: Nov. 5, 2024

(30) Foreign Application Priority Data
Dec. 27, 2023 (KR) 10-2023-0193551

(51) Int. Cl. G01N 21/31; G01N 21/25

(52) U.S. Cl. CPC G01N 21/31; G01N 21/255

(57) ABSTRACT

A liquid hydrogen ratio analysis system includes a heater that heats hydrogen to a room temperature, a receiving portion that accommodates the hydrogen heated by the heater and includes a transmission window through which a laser is transmitted, a spectral detector that detects an energy level scattered from the hydrogen by irradiating the laser to the hydrogen accommodated in the receiving portion through the transmission window, and a processor that is configured to determine a ratio of para hydrogen molecules to ortho hydrogen molecules in the hydrogen through the energy level detected by the spectral detector.

### CROSS-REFERENCE TO RELATED APPLICATION

The present application claims priority to Korean Patent Application No. 10-2023-0193551, filed on Dec. 27, 2023, the entire contents of which is incorporated herein for all purposes by this reference.

### BACKGROUND OF THE PRESENT DISCLOSURE

### Field of the Present Disclosure

The present disclosure relates to a liquid hydrogen ratio analysis system and a liquid hydrogen ratio analysis method.

### Description of Related art

Recently, as awareness of the crisis over the environment and depletion of oil resources has increased, research and development on a hydrogen fuel cell vehicle which is an eco-friendly vehicle have been highlighted.

In general, hydrogen fuel cell vehicles use room-temperature gaseous hydrogen stored at high pressure, but a liquid hydrogen storage method may be used to improve the storage capacity for hydrogen.

Meanwhile, hydrogen molecules may be classified into ortho hydrogen and para hydrogen depending on the spin direction of the atom. Ortho hydrogen may be formed when the nuclear spin directions of the hydrogen atoms are in different directions, and para hydrogen may be formed when the nuclear spin directions of the hydrogen atoms are in the same direction. Ortho hydrogen has relatively higher energy than para hydrogen, and the ratio of ortho hydrogen and para hydrogen may vary depending on temperature.

When liquid hydrogen is stored, ortho hydrogen may be converted to para hydrogen before the equilibrium state, and the liquid hydrogen may evaporate due to the heat generated when ortho hydrogen is converted to para hydrogen, which may reduce the storage performance of liquid hydrogen. Therefore, liquid hydrogen needs to be stored in an equilibrium state, and accordingly, the need for a system to analyze the ratio of liquid hydrogen is emerging.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system configured for analyzing the ratio of ortho hydrogen and para hydrogen in liquid hydrogen.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a liquid hydrogen ratio analysis system includes a heater that heats hydrogen to a predetermined temperature, a receiving portion that accommodates the hydrogen heated by the heater therein and includes a transmission window through which a laser is transmitted, a spectral detector that detects an energy level scattered from the hydrogen by irradiating the laser to the hydrogen accommodated in the receiving portion through the transmission window, and a processor that is operatively connected to the spectral detector and is configured to determine a ratio of para hydrogen molecules to ortho hydrogen molecules in the hydrogen through the energy level detected by the spectral detector.

The liquid hydrogen ratio analysis system may further include a temperature sensor portion that detects a temperature of the hydrogen heated by the heater.

The temperature sensor portion may be disposed inside the heater or the receiving portion.

The heater may include a heat exchange coil that exchanges heat with the hydrogen, and a temperature maintaining portion that accommodates the heat exchange coil therein and to maintain a temperature of the heat exchange coil to a constant temperature.

The heater may include a heat exchange coil that exchanges heat with the hydrogen, and a heating plate that supplies heat to the heat exchange coil.

The liquid hydrogen ratio analysis system may further include a discharge pipe that discharges the hydrogen from the receiving portion, and a flow control valve disposed on the discharge pipe.

The liquid hydrogen ratio analysis system may further include a flow meter disposed on the discharge pipe.

The liquid hydrogen ratio analysis system may further include an inlet pipe connected to the heater to supply the hydrogen, and a bypass pipe connected to the inlet pipe to bypass the hydrogen inside the inlet pipe to an outside of the inlet pipe.

The transmission window may be formed of quartz or sapphire glass.

The processor is configured to determine the ratio of the para hydrogen molecules to the ortho hydrogen molecules in the hydrogen based on multiplying a ratio of hydrogen molecules including a rotational quantum number (J) of zero in the hydrogen to hydrogen molecules including a rotational quantum number (J) of one in the hydrogen by an inverse of a calibration coefficient which is a function of temperature.

The calibration coefficient may be a value (F0/F1) obtaining by dividing a ratio (F0) of hydrogen molecules with a rotational quantum number (J) of zero to the para hydrogen molecules in a predetermined sample by a ratio (F1) of hydrogen molecules with a rotational quantum number (J) of one to the ortho hydrogen molecules in the predetermined sample.

The processor may be further configured for determining the calibration coefficient of a sample at a temperature corresponding to a temperature of the hydrogen in response that the temperature of the hydrogen is within a temperature range for which the calibration coefficient of the sample is known and determining the calibration coefficient by estimating the calibration coefficient of the sample at the temperature corresponding to the temperature of the hydrogen, in response that the temperature of the hydrogen is outside the temperature range for which the calibration coefficient of the sample is known.

According to an aspect of the present disclosure, a liquid hydrogen ratio analysis method includes heating hydrogen, irradiating a laser to the heated hydrogen, detecting an energy level scattered from the hydrogen by the laser, and determining, by a controller, a ratio of para hydrogen molecules to ortho hydrogen molecules in the hydrogen through the energy level.

The determining of the ratio of the para hydrogen molecules to the ortho hydrogen molecules in the hydrogen through the energy level, may include determining the ratio of the para hydrogen molecules to the ortho hydrogen molecules in the hydrogen by multiplying a ratio of hydrogen molecules including a rotational quantum number (J) of zero in the hydrogen to hydrogen molecules including a rotational quantum number (J) of one in the hydrogen by an inverse of a calibration coefficient which is a function of temperature.

The liquid hydrogen ratio analysis method may further include determining the calibration coefficient which is a value (F0/F1) obtaining by dividing a ratio (F0) of hydrogen molecules with a rotational quantum number (J) of zero to the para hydrogen molecules in a predetermined sample by a ratio (F1) of hydrogen molecules with a rotational quantum number (J) of one to the ortho hydrogen molecules in the predetermined sample.

The determining of the calibration coefficient may include determining the calibration coefficient of the sample at a temperature corresponding to the temperature of the hydrogen in response that the temperature of the hydrogen is within a temperature range for which the calibration coefficient of the sample is known, and determining the calibration coefficient by estimating the calibration coefficient of the sample at the temperature corresponding to the temperature of the hydrogen, in response that the temperature of the hydrogen is outside the temperature range for which the calibration coefficient of the sample is known.

The liquid hydrogen ratio analysis method may further include adjusting a flow rate of the hydrogen supplied to an area irradiated by the laser to within a predetermined range.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a liquid hydrogen ratio analysis system according to an exemplary embodiment of the present disclosure;

FIG. 2 is a schematic diagram of a liquid hydrogen ratio analysis system according to an exemplary embodiment of the present disclosure;

FIG. 3 is a schematic diagram of a liquid hydrogen ratio analysis system according to another exemplary embodiment of the present disclosure;

FIG. 4 is a schematic diagram of a heat exchange coil according to an exemplary embodiment of the present disclosure;

FIG. 5 is a flowchart of a liquid hydrogen ratio analysis method according to an exemplary embodiment of the present disclosure;

FIG. 6 is a schematic diagram of the Raman spectrum representing energy levels of gaseous hydrogen according to an exemplary embodiment of the present disclosure;

FIG. 7 is a schematic diagram of the Raman spectrum representing the energy levels of ortho hydrogen molecules and para hydrogen molecules in a low-temperature state, according to an exemplary embodiment of the present disclosure;

FIG. 8 is a schematic diagram showing a variation in a first ratio and a second ratio with temperature, according to an exemplary embodiment of the present disclosure.

FIG. 9 is a schematic diagram showing a variation in a calibration coefficient with temperature, according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as including meanings equal to the contextual meanings in the relevant field of art, and are not to be interpreted as including ideal or excessively formal meanings unless clearly defined as including such in the present application.

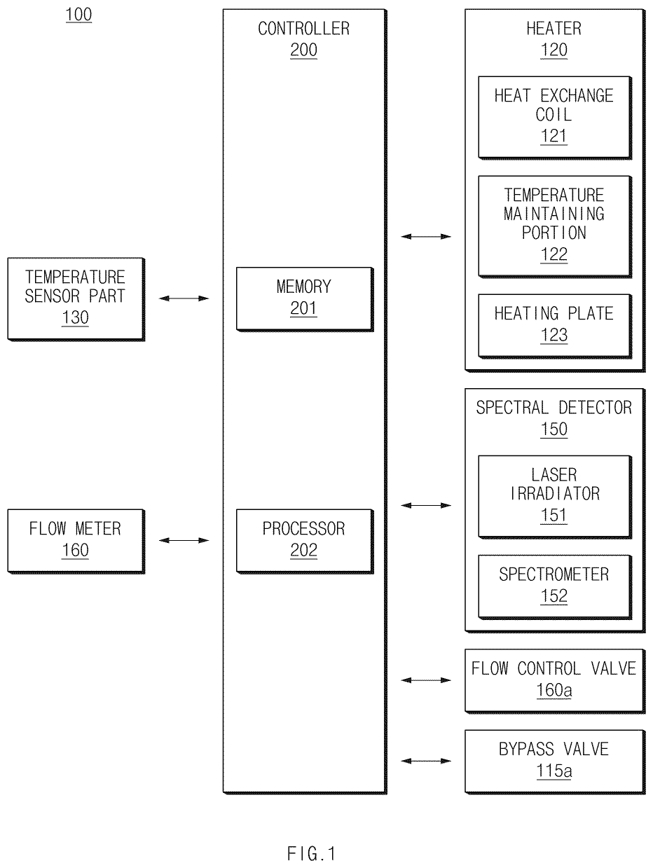

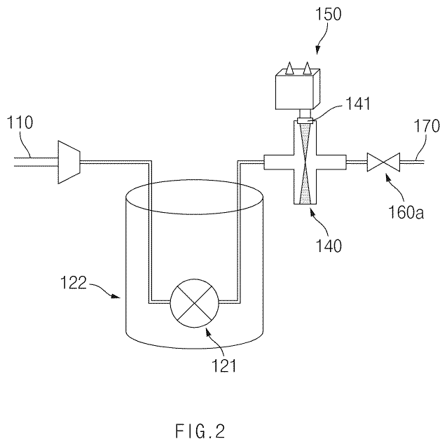

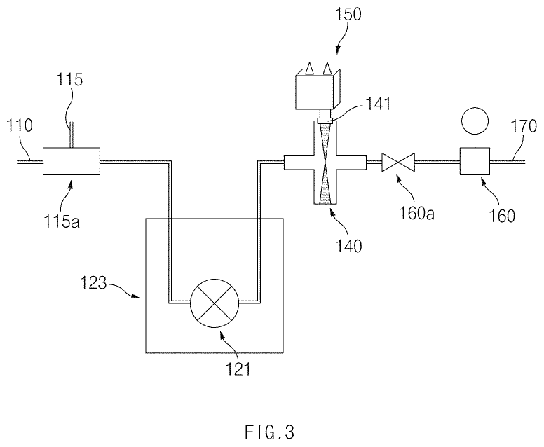

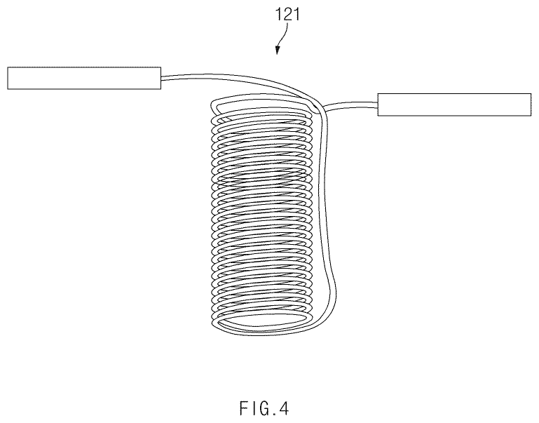

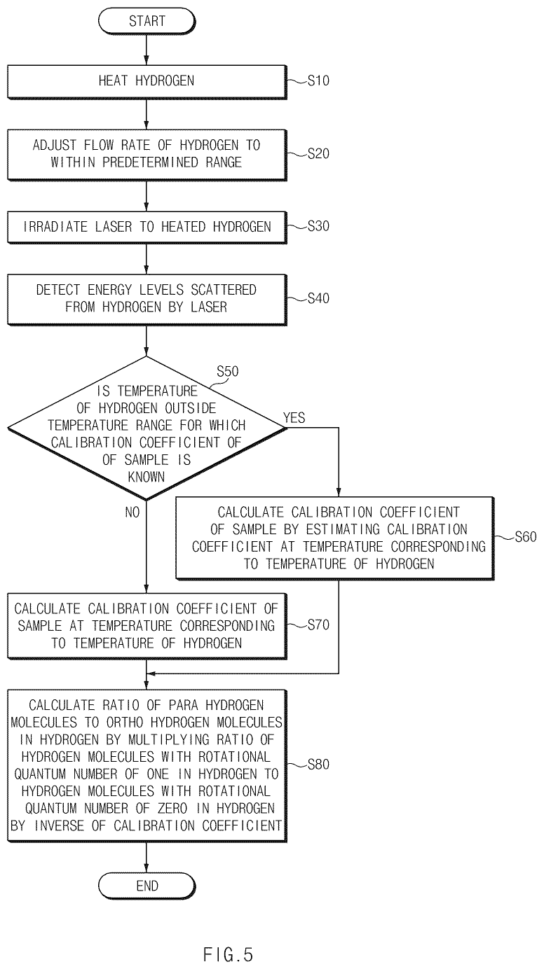

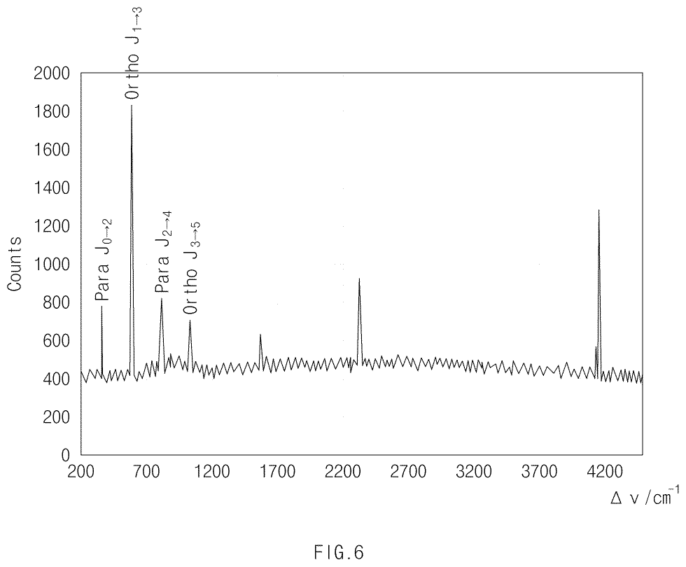

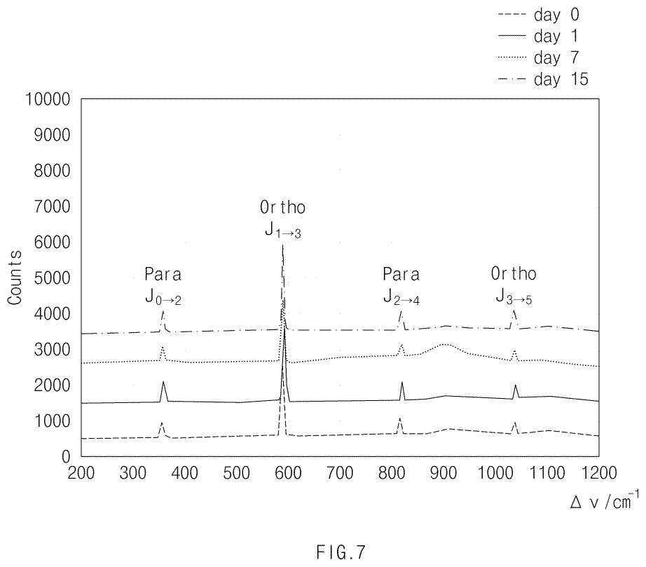

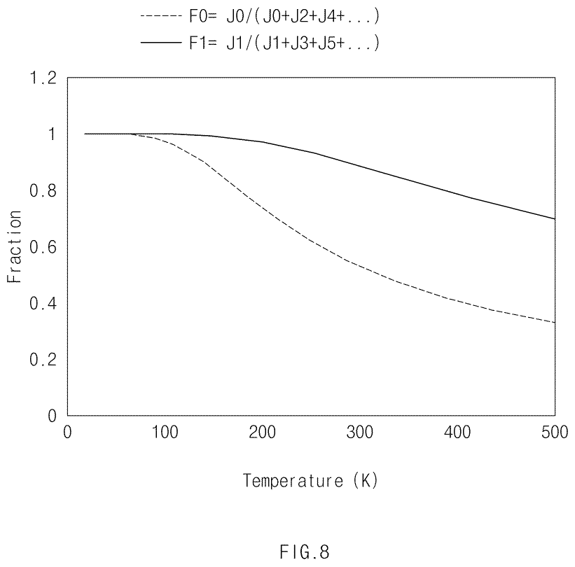

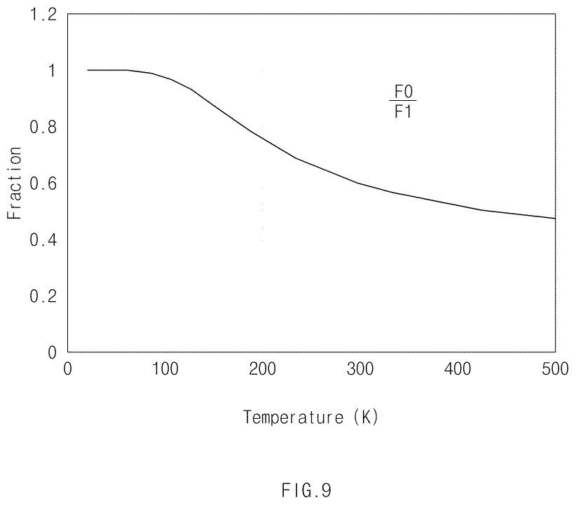

Hereinafter, various exemplary embodiments of the present disclosure will be described in detail with reference to FIG. 1, FIG. 2, FIG. 3, FIG. 4, FIG. 5, FIG. 6, FIG. 7, FIG. 8 and FIG. 9.

FIG. 1 is a block diagram of a liquid hydrogen ratio analysis system according to an exemplary embodiment of the present disclosure.

Referring to FIG. 1, a liquid hydrogen ratio analysis system 100 is a system for analyzing the ratio of ortho hydrogen to para hydrogen in liquid hydrogen stored in a storage tank provided in a hydrogen fuel cell vehicle.

Hydrogen may be stored in a liquid state in the storage tank of the hydrogen fuel cell vehicle to improve the storage capacity of the hydrogen.

Hydrogen has a boiling point of −252.87 degrees Celsius at atmospheric pressure, and is available as liquid hydrogen at temperatures below the boiling point and as gaseous hydrogen at temperatures above the boiling point. Hydrogen molecules may be categorized into ortho hydrogen and para hydrogen based on the spin orientation of hydrogen atom nucleus.

Ortho hydrogen is hydrogen in which hydrogen atoms are located on the same plane of molecules, and the spin orientations of the hydrogen atoms are opposite to each other at positions adjacent to each other. Para hydrogen is hydrogen where hydrogen atoms are located in different planes of molecules, and the hydrogen atoms have the same spin orientation at distant locations. Ortho hydrogen may have a relatively high magnetic rotational energy due to strong intramolecular spin interactions, while para hydrogen may have a relatively low magnetic rotational energy due to weak intramolecular spin interactions.

Ortho hydrogen and para hydrogen are determined by the spin interaction of electrons, and the spin state may affect the rotation, vibration, and magnetic properties of the molecules, and may also affect the thermodynamic properties of the molecules. The ratio of ortho hydrogen to para hydrogen may depend on the formation process and thermodynamic balance of the hydrogen molecules, such as the ratio of ortho hydrogen to para hydrogen at an absolute temperature of 20 K may be 0.2:99.8, and the ratio of ortho hydrogen to para hydrogen at room temperature may be 3:1.

In the instant case, when liquid hydrogen is added to the storage tank, it is necessary to analyze the ratio of ortho hydrogen to para hydrogen in the liquid hydrogen in advance. This is because ortho hydrogen may be converted to para hydrogen before the equilibrium between ortho hydrogen and para hydrogen is reached, and the heat generated by the conversion may cause the surrounding liquid hydrogen to evaporate into gaseous hydrogen. Furthermore, when the ratio of ortho hydrogen in the storage tank is higher than a certain level, the driving distance of the hydrogen fuel cell vehicle may be reduced.

To prevent the above-described issue, it is necessary to analyze in advance the ratio of ortho hydrogen to para hydrogen in the liquid hydrogen added to the storage tank, and the liquid hydrogen ratio analysis system 100 of the present disclosure may be used.

The liquid hydrogen ratio analysis system 100 may include a heater 120 provided to heat liquid hydrogen or low-temperature gaseous hydrogen introduced into a storage tank to a normal temperature, and a receiving portion 140 provided to receive gaseous hydrogen heated by the heater 120 and include a transmission window 141 (see FIG. 2) through which a laser is transmitted.

The heater 120 may heat liquid hydrogen or low-temperature gaseous hydrogen to gaseous hydrogen which is at room temperature. The reason why the heater 120 heats hydrogen, as will be described later, is because it is easy to determine the ratio of ortho hydrogen molecules to para hydrogen molecules of hydrogen compared to a predetermined sample.

The heater 120 may include a heat exchange coil 121 that exchanges heat with hydrogen to heat the supplied hydrogen. The heat exchange coil 121 may be water-cooled. A bath in which the temperature is maintained constant, may be used for the heat exchange coil 121. The heater 120 may include a temperature maintaining portion 122 provided to receive the heat exchange coil 121 and maintain the temperature of the heat exchange coil 121, and a heating plate 123, such as an induction heater, provided to supply heat to the heat exchange coil 121 to maintain the temperature of the heat exchange coil 121.

The liquid hydrogen ratio analysis system 100 may include a temperature sensor portion 130 provided to detect a temperature of gaseous hydrogen heated by the heater 120. The temperature sensor portion 130 may be provided to detect the temperature of the gaseous hydrogen heated by the heat exchange coil 121, and may be provided because a calibration coefficient or the like according to a calculation method to be described is a function of temperature. The temperature sensor portion 130 may be disposed in the interior of the heater 120 or the receiving portion 140.

The liquid hydrogen ratio analysis system 100 may include a spectral detector 150 provided to detect energy levels scattered from gaseous hydrogen when applying a laser to the gaseous hydrogen received inside the receiving portion 140.

The spectral detector 150 may include a laser irradiator 151 that irradiates a laser to the gaseous hydrogen through the transmission window 141 of the receiving portion 140, and a spectrometer 152 that detects energy levels scattered from the gaseous hydrogen when the gaseous hydrogen is irradiated from the laser irradiator 151.

The spectral detector 150 may be configured for Raman phenomena utilizing stroke scattering, in which molecules of gaseous hydrogen that have received strong energy by irradiating a laser to the gaseous hydrogen accommodated inside the receiving portion 140 re-emit energy and reach a state higher than original energy.

The liquid hydrogen ratio analysis system 100 may include a flow meter 160 provided to detect a flow rate of gaseous hydrogen introduced into the interior of the receiving portion 140. Because the molecules of gaseous hydrogen scattering using Raman phenomena change due to the flow rate, the flow rate of the gaseous hydrogen introduced into the receiving portion 140 may need to be adjusted to be detected by the spectral detector 150. To the present end, the liquid hydrogen ratio analysis system 100 may include a flow control valve 160a that adjusts the flow rate of gaseous hydrogen introduced into the interior of the receiving portion 140.

The liquid hydrogen ratio analysis system 100 may include a bypass valve 115a provided to adjust the amount of liquid hydrogen or low-temperature gaseous hydrogen introduced into the heater 120.

The liquid hydrogen ratio analysis system 100 may include a controller 200 that transmits and receives electrical signals to or from the bypass valve 115a, the heater 120, the temperature sensor portion 130, the spectral detector 150, the flow meter 160, and the flow control valve 160a, which are operatively connected to the controller 200.

The controller 200 may include a memory 201 and a processor 202. The memory 201 may include a volatile memory such as static random access memory (S-RAM) and dynamic random access memory (D-RAM) for temporarily storing data while power is supplied, and a non-volatile memory such as read only memory (ROM) and erasable programmable read only memory (EPROM) for preserving data even when power supply is cut off.

The processor 202 may include various logic circuits and arithmetic circuits, and may be configured for processing data according to a program provided from the memory 201 and generate control signals according to processing results.

Herein, in an exemplary embodiment of the present disclosure, the memory and the processor may be implemented as separate semiconductor circuits. Alternatively, the memory and the processor may be implemented as a single integrated semiconductor circuit. The processor may embody one or more processor(s).

The temperature sensor portion 130 may transmit the temperature of the gaseous hydrogen heated by the heater 120 to the processor 202. The flow meter 160 may detect and transmit the flow rate of the gaseous hydrogen introduced into the interior of the receiving portion 140 to the processor 202.

The processor 202 may be configured for controlling the laser irradiator 151 of the spectral detector 150 to irradiate a laser toward the transmission window 141, and may be configured for controlling the spectrometer 152 to detect energy levels scattered from the gaseous hydrogen.

The processor 202 may be configured to receive the energy levels scattered by the gaseous hydrogen from the spectrometer 152 and determine a ratio of para hydrogen molecules to ortho hydrogen molecules in liquid hydrogen.

The processor 202 may be configured for controlling the heater 120 to heat liquid hydrogen or low-temperature gaseous hydrogen. The processor 202 may be configured for controlling the flow control valve 160a to control the flow rate of gaseous hydrogen in the receiving portion 140. The processor 202 may be configured for controlling the bypass valve 115a to control the flow of liquid hydrogen or low-temperature gaseous hydrogen being supplied.

FIG. 2 is a schematic diagram of a liquid hydrogen ratio analysis system according to an exemplary embodiment of the present disclosure.

Referring to FIG. 2, the liquid hydrogen ratio analysis system 100 (see FIG. 1) may include an inlet pipe 110 that receives liquid hydrogen, and the heat exchange coil 121 connected to the inlet pipe 110. The diameter of the inlet pipe 110 may be approximately twice as large as the diameter of the heat exchange coil 121.

The heat exchange coil 121 may heat liquid hydrogen or low-temperature gaseous hydrogen flowing therein. In other words, the heat exchange coil 121 may be provided to exchange heat with the liquid hydrogen or the low-temperature gaseous hydrogen.

One end portion of the heat exchange coil 121 may be connected to the inlet pipe 110 and the other end portion of the heat exchange coil 121 may be connected to the receiving portion 140. As described above, the liquid hydrogen or low-temperature gaseous hydrogen supplied through the inlet pipe 110 may be heated to a certain temperature (e.g., room temperature) while it passes through the heat exchange coil 121 and may flow to the receiving portion 140.

On the other hand, it may be necessary that the temperature of the gaseous hydrogen flowing to the receiving portion 140 is constant. The reason for this is that the ratio of ortho hydrogen molecules and para hydrogen molecules of the hydrogen may not be constant when the temperature of the gaseous hydrogen is not constant. To the present end, the heat exchange coil 121 may be accommodated in the temperature maintaining portion 122. The heat exchange coil 121 may be disposed in the temperature maintaining portion 122 and maintained at a constant temperature.

The receiving portion 140 may include the transmission window 141 formed in a portion of one side facing the spectral detector 150 to transmit the laser of the spectral detector 150. The receiving portion 140 may be configured to receive gaseous hydrogen while energy levels of hydrogen molecules scattered by the laser being detected.

The transmission window 141 may be formed of quartz or sapphire glass for more stable detection of energy levels. The transmission window 141 may minimize the time to detect the energy levels of gaseous hydrogen, and because the transmission window 141 is in contact with gaseous hydrogen which is at room temperature, condensation which may occur on the transmission window 141 due to liquid hydrogen may be avoided.

The receiving portion 140 may be connected to a discharge pipe 170 provided to discharge the gaseous hydrogen in the receiving portion 140. The receiving portion 140 may be connected to the heat exchange coil 121 on one side and to the discharge pipe 170 on the other side. The discharge pipe 170 may be disposed to discharge gaseous hydrogen from the receiving portion 140, and the flow control valve 160a may be provided on the discharge pipe 170. The flow control valve 160a may adjust the flow rate of gaseous hydrogen in the receiving portion 140 by opening or closing the discharge pipe 170.

Thus, the liquid hydrogen ratio analysis system 100 may include the receiving portion 140, the discharge pipe 170 connected to the receiving portion 140, and the flow control valve 160a disposed on the discharge pipe 170.

FIG. 3 is a schematic diagram of a liquid hydrogen ratio analysis system according to another exemplary embodiment of the present disclosure.

Referring to FIG. 3, the liquid hydrogen ratio analysis system 100 (see FIG. 1) may include the inlet pipe 110 connected to the heat exchange coil 121 to supply hydrogen and a bypass pipe 115 connected to the inlet pipe 110 to discharge hydrogen in the inlet pipe 110. The bypass pipe 115 may be opened or closed by the bypass valve 115a disposed on the inlet pipe 110.

In other words, the processor 202 (see FIG. 1) may open the bypass pipe 115 via the bypass valve 115a operatively connected to the processor 202 to ensure that liquid hydrogen or low-temperature gaseous hydrogen is no longer supplied to the heat exchange coil 121. Furthermore, the processor 202 may close the bypass pipe 115 via the bypass valve 115a to connect the inlet pipe 110 and the heat exchange coil 121 to allow liquid hydrogen or low-temperature gaseous hydrogen to be supplied to the heat exchange coil 121.

The heat exchange coil 121 may be continuously supplied with heat by the heating plate 123 to maintain a constant temperature, and may exchange heat with liquid hydrogen or low-temperature gaseous hydrogen flowing through an interior of the heating plate 123.

According to the above-described structure, the liquid hydrogen ratio analysis system 100 (see FIG. 1) may be more portable compared to the liquid hydrogen ratio analysis system 100 of FIG. 2. That is, the ratio of para hydrogen molecules to ortho hydrogen molecules in the liquid hydrogen may be determined immediately when the liquid hydrogen is supplied to the storage tank.

The gaseous hydrogen may be received inside the receiving portion 140 connected to the heat exchange coil 121 or the heating plate 123 and energized by the spectral detector 150 and may re-emit less energy back than the energy supplied.

The liquid hydrogen ratio analysis system 100 may also include the flow control valve 160a and the flow meter 160 disposed on the discharge pipe 170. The flow meter 160 may be disposed on the discharge pipe 170 downstream of the flow control valve 160a with respect to the direction of flow of gaseous hydrogen.

The flow meter 160 may detect the flow rate of gaseous hydrogen in the discharge pipe 170 and transmit the flow rate to the processor 202. The processor 202 may cause the flow control valve 160a to open or close the discharge pipe 170 to adjust the flow rate of gaseous hydrogen in the receiving portion 140.

According to the above-described structure, the liquid hydrogen ratio analysis system 100 may adjust the flow rate of supplied liquid hydrogen or low-temperature gaseous hydrogen and the flow rate of discharged gaseous hydrogen, achieving a more accurate analysis of the ratio of para hydrogen molecules to ortho hydrogen molecules in the liquid hydrogen.

For configurations not described with reference to FIG. 3 in connection with other embodiments of the present disclosure, the contents described above with reference to FIG. 2 in relation to an exemplary embodiment of the present disclosure are used.

FIG. 4 is a schematic diagram of a heat exchange coil according to an exemplary embodiment of the present disclosure.

Referring to FIG. 4, the heat exchange coil 121 may be formed to exchange heat with liquid hydrogen flowing through its interior, and may have coil wires extending along a helical shape to make it less bulky.

Referring to FIG. 5, FIG. 6, FIG. 7, FIG. 8, and FIG. 9 below, a principle for determining a ratio of para hydrogen molecules to ortho hydrogen molecules in liquid hydrogen from the Raman spectrum, which is an energy level distribution of gaseous hydrogen, in the processor 202, and a liquid hydrogen ratio analysis method will be described.

FIG. 5 is a flowchart of a liquid hydrogen ratio analysis method according to an exemplary embodiment of the present disclosure. FIG. 6 is a schematic diagram of the Raman spectrum representing energy levels of gaseous hydrogen according to an exemplary embodiment of the present disclosure. FIG. 7 is a schematic diagram of the Raman spectrum representing the energy levels of ortho hydrogen molecules and para hydrogen molecules in a low-temperature state, according to an exemplary embodiment of the present disclosure. FIG. 8 is a schematic diagram showing a variation in a first ratio and a second ratio with temperature, according to an exemplary embodiment of the present disclosure. FIG. 9 is a schematic diagram showing a variation in a calibration coefficient with temperature, according to an exemplary embodiment of the present disclosure.

Referring to FIG. 5, FIG. 6, FIG. 7, FIG. 8, and FIG. 9, a liquid hydrogen ratio analysis method may include heating hydrogen (S10). Accordingly, hydrogen may be formed into room-temperature gaseous hydrogen.

The liquid hydrogen ratio analysis method may include adjusting a flow rate of gaseous hydrogen for laser irradiation to within a predetermined range (S20), and irradiating laser to the heated gaseous hydrogen (S30).

The adjusting of the flow rate of gaseous hydrogen within the predetermined range may include adjusting the flow rate of gaseous hydrogen supplied to an area irradiated by the laser within the predetermined range.

The liquid hydrogen ratio analysis method may include detecting energy levels scattered from the gaseous hydrogen by the laser after laser irradiation (S40). In the instant case, the distribution of the energy levels scattered from gaseous hydrogen may be the Raman spectrum.

As illustrated in FIG. 6, when a laser is irradiated to gaseous hydrogen received in the receiving portion 140 (see FIG. 2), the gaseous hydrogen may receive energy and re-emit it, and in the instant case, the distribution of energy levels may be the Raman spectrum.

The Raman spectrum may show energy levels emitted according to wavelengths through stroke scattering when hydrogen molecules in the vibrational ground state at room temperature receive strong light and return to a state with a higher energy level than the vibrational ground state.

In the Raman spectrum, hydrogen molecules with odd rotational quantum numbers (J) may be ortho hydrogen molecules, while hydrogen molecules with even rotational quantum numbers (J) may be para hydrogen molecules. As may be seen in FIG. 6, the energy emitted from a hydrogen molecule may vary depending on the rotational quantum number (J). The highest energy may be emitted when the rotational quantum number J is 0 and 1, and when the rotational quantum number J is even and odd, respectively.

Thus, the liquid hydrogen ratio analysis system 100 (see FIG. 1) may be configured to determine the ratio of para hydrogen molecules to ortho hydrogen molecules in the liquid hydrogen from the intensity of the signal when the rotational quantum number (J) is 0 and 1. Furthermore, the liquid hydrogen ratio analysis method according to an exemplary embodiment of the present disclosure may determine the ratio of para hydrogen molecules to ortho hydrogen molecules of liquid hydrogen from the intensity of the signal when the rotational quantum number J is 0 and 1.

As shown in FIG. 7, the energy difference caused by scattering from the hydrogen molecule when the rotational quantum number J is 0 and 3, respectively, may be clearly seen. It may be seen that the energy difference caused by scattering from hydrogen molecules is similar regardless of the time point from the time gaseous hydrogen is cooled to a temperature close to liquid hydrogen until 15 days have passed. This may show that the ratio of para hydrogen molecules to ortho hydrogen molecules in gaseous hydrogen does not change significantly with temperature. In other words, the ratio of para hydrogen molecules to ortho hydrogen molecules in gaseous hydrogen is similar to the ratio of para hydrogen molecules to ortho hydrogen molecules in liquid hydrogen.

However, the ratio of hydrogen molecules with a rotational quantum number (J) of zero to hydrogen molecules with a rotational quantum number (J) of one, which is obtained from the energy levels scattered by gaseous hydrogen, may not necessarily mean the ratio of ortho hydrogen molecules to para hydrogen molecules in liquid hydrogen.

It is necessary to use a calibration coefficient to obtain the ratio of ortho hydrogen molecules to para hydrogen molecules of liquid hydrogen from the ratio of hydrogen molecules with a rotational quantum number (J) of zero to hydrogen molecules with a rotational quantum number (J) of one, which is obtained from the energy levels scattered by gaseous hydrogen.

The calibration coefficient may be a value derived from a predetermined sample. The predetermined sample may be a sample (hereinafter “sample”) in which a first ratio F1, the ratio of hydrogen molecules including a rotational quantum number J of 1 to ortho hydrogen molecules, and a second ratio F0, the ratio of hydrogen molecules including a rotational quantum number J of 0 to para hydrogen molecules, are known. The calibration coefficient may be the value of the second ratio F0, with respect to the first ratio F1. That is, the calibration coefficient may be a value obtained by dividing the second ratio FO by the first ratio F1 (F0/F1).

However, the values of the first ratio F1 and the second ratio F0 for determining the calibration coefficient may be determined based on the temperature of the sample, as shown in FIG. 8 and FIG. 9. Thus, the calibration coefficient may be determined by comparing the temperature of the gaseous hydrogen with the temperature of the sample.

On the other hand, the value of the calibration coefficient may be determined in different ways depending on whether the temperature of the gaseous hydrogen is within a temperature range for which the calibration coefficient of the sample is known.

First, the liquid hydrogen ratio analysis method may include determining whether the temperature of the gaseous hydrogen is within a temperature range for which the calibration coefficient of the sample is known (S50).

When the temperature of the gaseous hydrogen is within the temperature range for which the calibration coefficient of the sample is known (NO in S50), the liquid hydrogen ratio analysis method may include determining a calibration coefficient of the sample at a temperature corresponding to the temperature of the gaseous hydrogen (70).

On the other hand, when the temperature of the gaseous hydrogen is outside the temperature range for which the calibration coefficient of the sample is known (YES in S50), the liquid hydrogen ratio analysis method may include determining the calibration coefficient by estimating a calibration coefficient of the sample at the temperature corresponding to the temperature of the gaseous hydrogen (S60).

In the instant case, the determining of the calibration coefficient by estimating the calibration coefficient of the sample at the temperature corresponding to the temperature of the gaseous hydrogen, from the temperature range for which the calibration coefficient of the sample is known (S60) may mean estimating and calculating, from a well-known graph for relationship between the calibration coefficient of the sample and the temperature, the calibration coefficient of the sample at a temperature outside the graph, as shown in FIG. 9.

That is, the processor 202 may be configured to determine the calibration coefficient of the sample at the temperature corresponding to the temperature of the gaseous hydrogen, based on the fact that the temperature of the gaseous hydrogen is within the temperature range for which the calibration coefficient of the sample is known, and estimate and determine the calibration coefficient of the sample at temperature corresponding to the temperature of gaseous hydrogen based on the fact that the temperature of gaseous hydrogen is outside the temperature range for which the calibration coefficient of the sample is known.

Thereafter, the liquid hydrogen ratio analysis method may include determining a ratio of para hydrogen molecules to ortho hydrogen molecules in the liquid hydrogen by multiplying the ratio of hydrogen molecules including a rotational quantum number (J) of one in the gaseous hydrogen to hydrogen molecules including a rotational quantum number (J) of zero in the gaseous hydrogen by the inverse of a calibration coefficient which is a function of temperature (S80).

As described above, the ratio of the para hydrogen molecules to the ortho hydrogen molecules in gaseous hydrogen may correspond to the ratio of the para hydrogen molecules to the ortho hydrogen molecules in liquid hydrogen, and the ratio of the para hydrogen molecules to the ortho hydrogen molecules in the liquid hydrogen may be determined by multiplying the ratio of the hydrogen molecules including a rotational quantum number (J) of zero in the gaseous hydrogen to the hydrogen molecules including a rotational quantum number (J) of one in the gaseous hydrogen by the inverse of the calibration coefficient.

Through the process described above, the liquid hydrogen ratio analysis system may immediately identify the ratio of para hydrogen molecules to ortho hydrogen molecules in liquid hydrogen stored in a storage tank on site, improving the storage performance of liquid hydrogen or preventing the driving performance of a hydrogen fuel cell vehicle from declining in advance.

The above description is merely illustrative of the technical idea of the present disclosure, and various modifications and variations may be made without departing from the essential characteristics of the present disclosure by those skilled in the art to which the present disclosure pertains.

Accordingly, the exemplary embodiment included in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may analyze the ratio of ortho hydrogen and para hydrogen in liquid hydrogen, thus improving the quality of stored liquid hydrogen.

Furthermore, the present technology may analyze the ratio of ortho hydrogen and para hydrogen in liquid hydrogen, thus improving a driving range by hydrogen fuel cells.

Furthermore, in the present technology, room-temperature gaseous hydrogen is accommodated in the receiving portion with a transmission window, preventing condensation to stabilize the energy level of gaseous hydrogen.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A liquid hydrogen ratio analysis system comprising:
a heater provided to heat hydrogen to a predetermined temperature;
a receiving portion provided to accommodate the hydrogen heated by the heater therein and including a transmission window through which a laser is transmitted;
a spectral detector provided to detect an energy level scattered from the hydrogen by irradiating the laser to the hydrogen accommodated in the receiving portion through the transmission window; and
a processor operatively connected to the spectral detector and configured to determine a ratio of para hydrogen molecules to ortho hydrogen molecules in the hydrogen through the energy level detected by the spectral detector.

2. The liquid hydrogen ratio analysis system of claim 1, further including:
a temperature sensor portion provided to detect a temperature of the hydrogen heated by the heater.

3. The liquid hydrogen ratio analysis system of claim 2, wherein the temperature sensor portion is disposed inside the heater or the receiving portion.

4. The liquid hydrogen ratio analysis system of claim 1, wherein the heater includes:
a heat exchange coil provided to exchange heat with the hydrogen; and
a temperature maintaining portion provided to accommodate the heat exchange coil therein and to maintain a temperature of the heat exchange coil to a constant temperature.

5. The liquid hydrogen ratio analysis system of claim 1, wherein the heater includes a heat exchange coil provided to exchange heat with the hydrogen.

6. The liquid hydrogen ratio analysis system of claim 5, wherein the heater includes a heating plate provided to supply heat to the heat exchange coil.

7. The liquid hydrogen ratio analysis system of claim 1, further including:
a discharge pipe provided to discharge the hydrogen from the receiving portion; and
a flow control valve disposed on the discharge pipe.

8. The liquid hydrogen ratio analysis system of claim 7, further including:
a flow meter disposed on the discharge pipe.

9. The liquid hydrogen ratio analysis system of claim 1, further including:
an inlet pipe connected to the heater to supply the hydrogen; and
a bypass pipe connected to the inlet pipe to bypass the hydrogen inside the inlet pipe to an outside of the inlet pipe.

10. The liquid hydrogen ratio analysis system of claim 1, wherein the transmission window is formed of quartz or sapphire glass.

11. The liquid hydrogen ratio analysis system of claim 2, wherein the processor is further configured to determine the ratio of the para hydrogen molecules to the ortho hydrogen molecules in the hydrogen based on multiplying a ratio of hydrogen molecules including a rotational quantum number (J) of zero in the hydrogen to hydrogen molecules including a rotational quantum number (J) of one in the hydrogen by an inverse of a calibration coefficient which is a function of the temperature.

12. The liquid hydrogen ratio analysis system of claim 11, wherein the calibration coefficient is a value (F0/F1) obtaining by dividing a ratio (F0) of hydrogen molecules with a rotational quantum number (J) of zero to the para hydrogen molecules in a predetermined sample by a ratio (F1) of hydrogen molecules with a rotational quantum number (J) of one to the ortho hydrogen molecules in the predetermined sample.

13. The liquid hydrogen ratio analysis system of claim 11, wherein the processor is further configured for:
determining the calibration coefficient of a sample at a temperature corresponding to a temperature of the hydrogen in response that the temperature of the hydrogen is within a temperature range for which the calibration coefficient of the sample is known; and
determining the calibration coefficient by estimating the calibration coefficient of the sample at the temperature corresponding to the temperature of the hydrogen, in response that the temperature of the hydrogen is outside the temperature range for which the calibration coefficient of the sample is known.

14. A liquid hydrogen ratio analysis method comprising:
heating hydrogen:
irradiating a laser to the heated hydrogen;
detecting an energy level scattered from the hydrogen by the laser; and
determining, by a controller, a ratio of para hydrogen molecules to ortho hydrogen molecules in the hydrogen through the energy level.

15. The liquid hydrogen ratio analysis method of claim 14, wherein the determining of the ratio of the para hydrogen molecules to the ortho hydrogen molecules in the hydrogen through the energy level, includes determining the ratio of the para hydrogen molecules to the ortho hydrogen molecules in the hydrogen by multiplying a ratio of hydrogen molecules including a rotational quantum number (J) of zero in the hydrogen to hydrogen molecules including a rotational quantum number (J) of one in the hydrogen by an inverse of a calibration coefficient which is a function of temperature of the hydrogen.

16. The liquid hydrogen ratio analysis method of claim 15, further including:
determining, by the controller, the calibration coefficient which is a value (F0/F1) obtaining by dividing a ratio (F0) of hydrogen molecules with a rotational quantum number (J) of zero to the para hydrogen molecules in a predetermined sample by a ratio (F1) of hydrogen molecules with a rotational quantum number (J) of one to the ortho hydrogen molecules in the predetermined sample.

17. The liquid hydrogen ratio analysis method of claim 16, wherein the determining of the calibration coefficient includes:
determining the calibration coefficient of the sample at a temperature corresponding to the temperature of the hydrogen in response that the temperature of the hydrogen is within a temperature range for which the calibration coefficient of the sample is known; and
determining the calibration coefficient by estimating the calibration coefficient of the sample at the temperature corresponding to the temperature of the hydrogen, in response that the temperature of the hydrogen is outside the temperature range for which the calibration coefficient of the sample is known.

18. The liquid hydrogen ratio analysis method of claim 14, further including:
adjusting a flow rate of the hydrogen supplied to an area irradiated by the laser to within a predetermined range.
